(19) United States
(12) Patent Application Publication
(10) Pub. No.: US 2026/0269551 A1
(43) Pub. Date: Sep. 10, 2026

(54) CABLE POINTING TOOL

(71) Applicant: KING FAHD UNIVERSITY OF PETROLEUM AND MINERALS, Dhahran (SA)

(72) Inventors: Ali Dheyaa JAWAD, Baghdad (IQ); Ahmed Zarzor Hussien YASERI, Dhahran (SA)

(73) Assignee: KING FAHD UNIVERSITY OF PETROLEUM AND MINERALS, Dhahran (SA)

(21) Appl. No.: 19/388,786

(22) Filed: Nov. 13, 2025

Related U.S. Application Data
(60) Provisional application No. 63/769,332, filed on Mar. 10, 2025.

(51) Int. Cl. H01R 43/28; H02K 11/28

(52) U.S. Cl. CPC H01R 43/28; H02K 11/28

(57) ABSTRACT

A cable pointing tool includes an electrical motor system. The electrical motor system includes an electrical motor and a grinder stone. The electrical motor powers the grinder stone to sharpen an end of a cable. The cable pointing tool includes a pointing system. The pointing system includes a cable holder to hold the cable and a mechanical dual-handle system to guide the cable towards the grinder stone. The cable pointing tool includes a main base to mount the electrical motor system and the pointing system.

### CROSS-REFERENCE TO RELATED APPLICATIONS

The present application is based upon and claims the benefit of priority from U.S. Provisional Application No. 63/769,332, filed Mar. 10, 2025, the entire contents of which are incorporated herein by reference.

### BACKGROUND

### Technical Field

The present disclosure is directed to a tool for sharpening ends of a cable into a pointed configuration, and more particularly relates to a cable pointing tool.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Wires and cables are essential components used to transmit electromagnetic energy and information over long distances across various industries, including telecommunications, power distribution, automotives, aerospace, electronics, mining and petroleum engineering. In the petroleum industry, specialized logging cables are used for wireline logging operations. These operations involve lowering instruments into a wellbore to collect geological data. These cables consist of multiple layers of materials, including insulated cores that protect conducting elements and outer sheaths that guard against external damage caused by harsh environmental conditions. The cables are available in various configurations such as coaxial, fiber optics, and shielded cables with outer and inner protective layers made from insulation materials such as PVC and rubber. These materials are designed to withstand high temperatures and corrosive environments.

However, before installation and use, the cables must be precisely stripped in accordance with industry standards. The stripping process involves careful removal of insulation layers to expose the conductor for proper connection. The process requires precision as insufficient stripping may result in inadequate exposure of the conductor, while excessive stripping can damage the conductor and compromise structural integrity of the cable. Properly stripped cables pass through control components and connection points more efficiently than unstripped cables. Precisely stripped cables further improve installation efficiency, reduce mechanical wear and tear during repetitive use, maintain integrity and extend service life.

Traditionally, the cables were stripped using manual peeling devices operated by skilled workers. The workers have to continuously rotate the devices by hand while maintaining appropriate pressure and alignment. Some solutions have focused on creating a tapered or pointed cable ends to facilitate smoother passage through wellbore restrictions, while others have emphasized protective measures to reduce cable wear during operations. Despite these advancements, existing solutions still present significant limitations and challenges. The manual peeling process is time-consuming and physically demanding, requires the workers to hold and operate the devices continuously. While automated machines address some labor-related challenge, they often lack the precision control needed for specialized applications.

US20090100681A1 describes a coaxial cable stripping tool with an adjustable mechanism for preparing a cable end for attachment to a connector. The connector includes a first and a second cutting mechanisms located at opposite ends of the tool. The first mechanism uses a pair of jaws, and a planar cutting blade mounted in a replaceable blade cartridge to cut through the outer conductor and inner insulation to the inner conductor. The second cutting mechanism uses a double-edged cutting blade and an adjustable stop that contacts the first cutting mechanism to control the distance of outer insulation removed beyond the first cut. U.S. Pat. No. 12,294,204B2 describes an armored cable stripping tool for cutting an armor includes a cable receiving handle and a saw handle movably mounted to the cable receiving handle. A saw assembly includes at least one saw blade, supported by the saw handle. The saw assembly and moveable relative to the cable receiving handle. The saw assembly is configured to simultaneously cut the armor sheathing of the cable in two places. However, these references do not disclose a tool to hold and adjust cable and sharpen end of the cable with precision with less manual effort.

Each of the aforementioned references suffers from one or more drawbacks that hinder their adoption, such as optimal end configuration, wear and tear of cables during processing, delayed operations and inconsistent peeling. Furthermore, manual stripping is prone to inconsistency due to human errors that may result in variable strip lengths of the cable. These limitations highlight the need for a cable pointing tool that delivers consistent precision and meets industrial requirements. Accordingly, it is one object of the present disclosure to provide a cable pointing tool that addresses the limitations of traditional cable stripping devices.

### SUMMARY

In an exemplary embodiment, a cable pointing tool is described. The cable pointing tool includes an electrical motor system. The electrical motor system includes an electrical motor and a grinder stone. The grinder stone is powered by the electrical motor to sharpen an end of a cable. The cable pointing tool includes a pointing system. The pointing system includes a cable holder and a mechanical dual-handle system, and the cable holder is configured to hold the cable. The mechanical dual-handle system is configured to guide the cable towards the grinder stone. The cable pointing tool includes a main base on which the electrical motor system and the pointing system are mounted.

In an embodiment, the electrical motor system further includes a protective shield covering the grinder stone.

In an embodiment, the pointing system further includes a track on which the cable holder is mounted such that the cable holder is movable along a moving axis of the track.

In an embodiment, the mechanical dual-handle system includes a first handle module configured to move the cable holder along the moving axis of the track.

In an embodiment, the first handle module includes a first base and a first handle connected to the first base through a first axle.

In an embodiment, the track is mounted onto the first base.

In an embodiment, the cable holder is moved along the moving axis of the track through rotation of the first handle.

In an embodiment, the mechanical dual-handle system further includes a second handle module configured to move the cable holder along an axis perpendicular to the moving axis of the track.

In an embodiment, the second handle module includes a second base and a second handle connected to the second base through a wheel and a second axle.

In an embodiment, the first handle module is mounted onto the second base.

In an embodiment, the cable holder is moved along the axis perpendicular to the moving axis of the track through rotation of the second handle.

In an embodiment, the second base includes a gear configured to move the cable holder along the moving axis of the track.

In an embodiment, the grinder stone is conical-shaped.

In an embodiment, the conical-shaped grinder stone has a base surface, wherein ratio between an outer diameter and an inner diameter is around 1.4 to 1.6.

In an embodiment, the electrical motor system further includes a control system configured to control motor activation, motor deactivation, and speed regulation of the electrical motor.

In an embodiment, the control system is an electrical or hydraulic system.

In an embodiment, the cable pointing tool further includes an emergency stop system configured to halt the electrical motor in case of an emergency.

In an embodiment, the emergency stop system includes an easily accessible switch that immediately halts the electrical motor in case of the emergency.

In an embodiment, the cable pointing tool further includes a safety interlock configured to ensure the grinder stone operates only when the cable is correctly positioned and a protective shield is in place.

In an embodiment, the cable pointing tool further includes an overload protection configured to prevent the electrical motor from operating under excessive load.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a perspective view of a cable pointing tool, according to certain embodiments.

FIG. 1B is a side view of the cable pointing tool, according to certain embodiments.

FIG. 2 is a side view of an electrical motor system of the cable pointing tool, according to certain embodiments.

FIG. 3 is a perspective view of a grinder stone of the electrical motor system, according to certain embodiments.

FIG. 4 is a bottom view of a cable holder of the cable pointing tool, according to certain embodiments.

FIG. 5 is a perspective view of a housing of the cable holder, according to certain embodiments.

FIG. 6 is a perspective view of a first handle of a first handle module of the cable pointing tool, according to certain embodiments.

FIG. 7A is a schematic partial perspective view of the cable pointing tool showing a gear in a mounting position thereof, according to certain embodiments.

FIG. 7B is a perspective view of the gear, according to certain embodiments.

FIG. 8 is a schematic block diagram illustrating the cable pointing tool with a control system, including an emergency stop system and a safety interlock, according to certain embodiments.

FIG. 9A is a perspective view of a track of the cable pointing tool, according to certain embodiments.

FIG. 9B is a bottom view of the track of the cable pointing tool, according to certain embodiments.

FIG. 10 is a bottom perspective view of a first base and a second base of the cable pointing tool, according to certain embodiments.

FIG. 11 is a perspective view of a third base of the cable pointing tool, according to certain embodiments.

FIG. 12 is a perspective view of a main base of the cable pointing tool, according to certain embodiments.

FIG. 13A is a perspective view of a base column of the cable pointing tool, according to certain embodiments.

FIG. 13B is a perspective view of a fourth base of the cable pointing tool, according to certain embodiments.

FIG. 13C is a perspective view of a fifth base of the cable pointing tool, according to certain embodiments.

FIG. 14 is a graphical representation measuring resistance for pointed cable vs non-pointed cable, according to certain embodiments.

FIG. 15 is a tabular representation showing cable integrity and longevity data post operation for the pointed cable vs a non-pointed cable, according to certain embodiments.

FIG. 16 is an illustration of a non-limiting example of details of a controller used in a computing system, according to certain embodiments.

FIG. 17 is an exemplary schematic diagram of a data processing system used within the computing system, according to certain embodiments.

FIG. 18 is an exemplary schematic diagram of a processor used with the computing system, according to certain embodiments.

FIG. 19 is an illustration of a non-limiting example of distributed components which may share processing with the controller, according to certain embodiments.

### DETAILED DESCRIPTION

In the drawings, like reference numerals designate identical or corresponding parts throughout several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

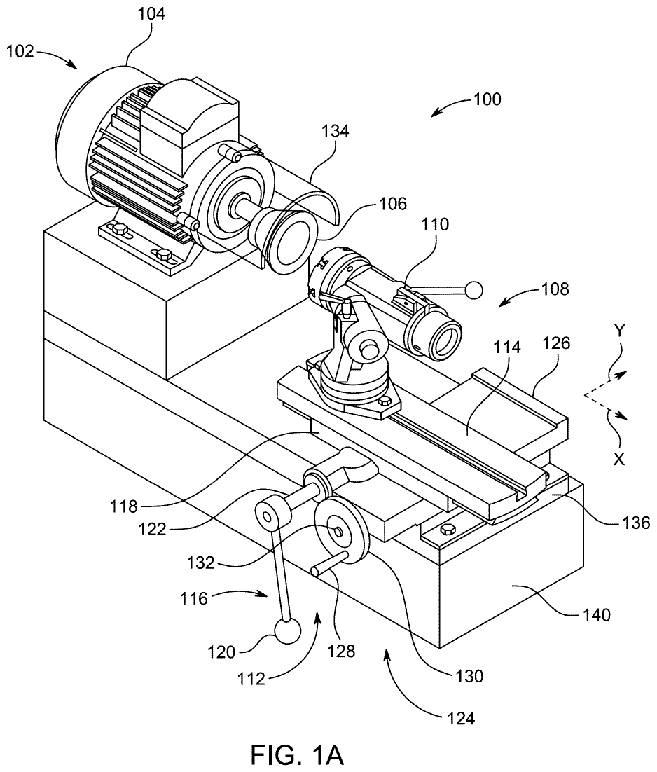

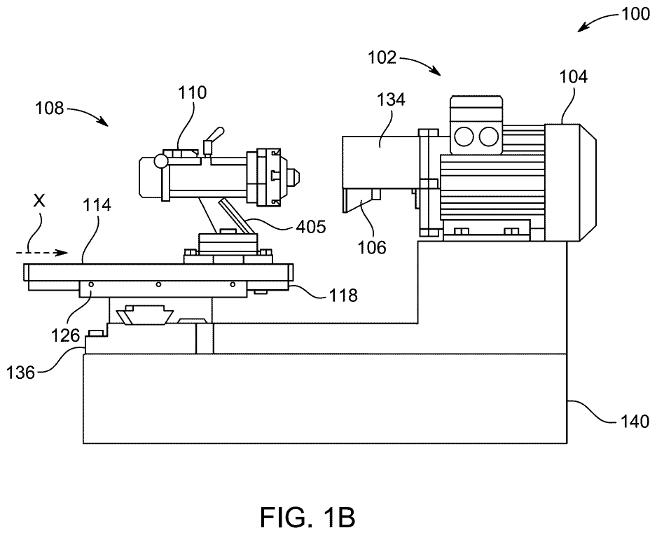

Aspects of the present disclosure are directed towards a cable pointing tool specifically designed for wireline logging applications. The cable pointing tool includes multiple interconnected components arranged in a specific configuration to achieve the technical effect of producing precisely pointed cable ends. The precisely pointed cable ends provide smoother navigation through wellbore obstructions. The precisely pointed cables further improve cable preparation quality and consistency. The cable pointing tool eliminates or reduces manual operation, and thereby saves both time and energy. The cable pointing tool provides consistent stripping of various cable types and reduces operator fatigue and equipment replacement costs. Referring to FIG. 1A and FIG. 1B in combination, illustrated are different views of a cable pointing tool 100, according to an embodiment of the present disclosure. As illustrated, the cable pointing tool 100 refers to a cutting tool specifically configured to produce precisely pointed cable ends through a controlled stripping process. The cable pointing tool 100 shapes an end of a cable into a tapered or sharpened form for facilitating smoother insertion into connectors, or restricted passageways.

The cable pointing tool 100 may be used across various industries including telecommunication networks, electrical distribution systems, and in petroleum engineering applications. In applications, cables are frequently subjected to extreme environmental conditions and mechanical stress during use. The precisely pointed cable end minimizes wear and tear during operations. The cable pointing tool 100 provides uniform shaping of the cable end into a tapered or sharpened form and increases accuracy and consistency of cable preparation.

The cable pointing tool 100 includes an electrical motor system 102 as a primary functional unit for cable stripping operations. The electrical motor system 102 is securely mounted on one end of a main base 140 using a plurality of fastening members and mounting holes. The mounting holes are precisely configured to align with corresponding holes on a mounting surface of the main base 140. The plurality of fastening members such as bolts or screws may be used to secure the electrical motor system 102 in proper operational position to the mounting surface of the main base 140.

The electrical motor system 102 includes an electrical motor 104 and a grinder stone 106. The electrical motor system 102 is electrically connected to a power supply to provide electric current for sustained operation throughout the cable preparation process. The electrical motor 104 converts electrical energy into mechanical energy to rotate the grinder stone 106.

The grinder stone 106 functions as a sharpening tool configured to sharpen the ends of the cable into the precisely shaped pointed ends.

In an embodiment, the grinder stone 106 is a primary cable material removal component of the cable pointing tool 100. The grinder stone 106 is mechanically coupled to the electrical motor 104 using a spindle or a rotary coupling. The spindle coupling is configured to transmit torque directly to the grinder stone 106.

The electrical motor system 102 further includes a protective shield 134 positioned on the electrical motor 104 to cover the grinder stone 106. The protective shield 134 performs dual functions, prevent direct operator contact with the grinder stone 106 and contains debris generated during the stripping of the cable.

The cable pointing tool 100 further includes a pointing system 108 configured to provide accurate cable positioning relative to the grinding stone 106. The pointing system 108 includes a cable holder 110 and a mechanical dual-handle system 112 mounted securely on the main base 140.

The cable holder 110 functions as a primary cable retention and directional guidance component, specifically configured to securely hold cables of varying sizes and compositions, while directing the cable towards the grinding stone 106.

The mechanical dual-handle system 112 functions as a precision guidance system for positioning the cable in relation to the grinder stone 106. The mechanical dual-handle system 112 provides precise control over cable positioning towards the grinder stone 106. The mechanical dual-handle system 112 provides both coarse and fine positional adjustments along multiple axes for better operational accuracy. The mechanical dual-handle system 112 allows the operator to maintain cable position alignment, correct angle, consistent contact pressure, and controlled withdrawal of the sharpened cable from the grinding stone 106.

In an embodiment, a track 114 serves as a supporting and guiding component of the cable holder 110. The cable holder 110 is securely mounted onto the track 114 in a specific configuration such that the cable holder 110 is movable along a moving axis ‘X’ of the track 114. The track 114 is mounted onto a first base 118 which provides structural stability and ensures that movement along the moving axis ‘X’ remains precise and repeatable. The track 114 allows the cable holder 110 to slide or move smoothly along the track 114.

In a preferable embodiment of the invention, the cable pointing tool includes a second cable holder mounted on the track 114 directly behind the cable holder 110 and separated from the cable holder 110 by a distance of at least the axial length of the cable holder 110. The second cable holder functions as a secondary cable retention and guidance component. The second cable holder has a compressible interior cylinder that is lined with a compressible material. The compressible material is preferably a closed cell polyurethane foam. The compressible material permits contact with a cable undergoing pointing with the cable pointing tool and secured with the cable holder 110. The cable holder 110 functions to secure the cable in a locked position. The cable holder 110 advances the cable towards the cable pointing tool and grinding stone in line with the track 114. In contrast, the second holding tool is preferably mounted in a fixed position and remains in the fixed position even when the cable holding holder 110 is advanced, e.g., the cable holder 110 advances on the track 114 whereas the second cable holder does not move. The cable, held securely in the cable holder 110, is permitted to advance by slippage through the compressible material of secondary cable holder, and is only lightly held by the compressible polyurethane foam. In this manner, the cable may be advanced stably being fixedly secured in each axis by the cable holder 110 and movably secured such that the cable advances forward through the long axis of the second cable holder thereby permitting control of the cable movement without interference from twisting of the cable tail. The second cable holder is preferably of approximately the same dimensions as the cable holder 110 but is different from the cable holder 110 by its function to permit slippage of the cable along the access of the track 114.

The mechanical dual-handle system 112 includes a first handle module 116 configured to move the cable holder 110 along the moving axis ‘X’ of the track 114. The first handle module 116 includes the first base 118 and a first handle 120 connected to the first base 118 through a first axle 122 for a controlled movement. The first axle 122 functions as the rotational pivot point and allows the operator to transmit controlled motion to the cable holder 110. The first handle 120 is configured to move the cable holder 110 along the moving axis ‘X’ through a rotation thereof.

In an embodiment, the mechanical dual-handle system 112 further includes a second handle module 124 configured to move the cable holder 110 along an axis ‘Y’ perpendicular to the moving axis ‘X’ of the track 114. The second handle module 124 includes a second base 126 and a second handle 128 connected to the second base 126 through a wheel 130 and a second axle 132. The second handle 128 is configured to move the cable holder 110 along the axis ‘Y’ perpendicular to the moving axis ‘X’ of the track 114 through rotation thereof. The wheel 130 provides smooth lateral movement, while the second axle 132 provides rotational control. The second base 126 is further movably supported on a third base 136 to move along the axis ‘Y’ perpendicular to the moving axis ‘X’ of the track 114. The third base 136 is detachably attached to the main base 140 using a plurality of fastening members. The dual-axis configuration ensures that the cable holder 110 to be positioned with high precision in both longitudinal and transverse directions. In an embodiment, the first handle module 116 is mounted onto the second base 126 for moving the cable holder 110 along the moving axis ‘X’.

In operation, the operator guides the cable holder 110 into a desired position using the mechanical dual-handle system 112. The first handle module 116 enables movement of the cable holder 110 along the moving axis ‘X’ of the track 114, while the second handle module 124 allows adjustment of the cable holder 110 along the axis ‘Y’ perpendicular to the moving axis ‘X’.

In an embodiment, the electrical motor system 102 and the pointing system 108 are mounted on the main base 140. The main base 140 serves as the foundational support structure for the cable pointing tool 100. The electrical motor system 102 and the pointing system 108 may be mounted using bolts, brackets, or integrated slots. The main base 140 keeps the electrical motor 104 and the pointing system 108 maintain synchronized positioning, allowing efficient transfer of motion and precise cable handling.

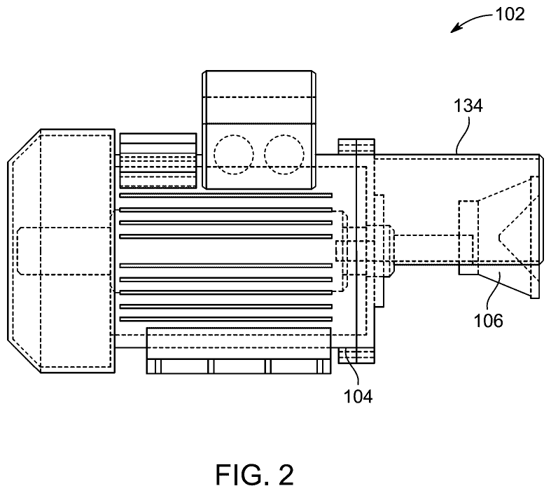

Referring to FIG. 2 is a side view of the electrical motor system 102 of the cable pointing tool 100, according to certain embodiments. As described in FIG. 1A and FIG. 1B, according to the present disclosure, the electrical motor 104 is an alternate current (AC) motor. The electrical motor 104 may be a single-phase or a three-phase AC motor. The AC motor may be selected to provide operational flexibility, precise speed control, and higher torque output through utilization of the electric current.

The electrical motor 104 may include one or more integrated components including a stator configured to provide a stable magnetic field, and a rotor containing a rotating armature that converts electrical energy into mechanical rotational motion.

In an embodiment, the electrical motor 104 may operate at a lower rotational speed when stripping soft cables such as copper conductors with PVC insulation or flexible silicone coated cables. The electrical motor 104 may operate at a significantly higher speed for stripping hard cables such as steel reinforced cables or cables withs multiple metallic shielding layers.

In an embodiment, precision force generated by the electrical motor 104 may be defined as:

$$F = ( {d}^{2} * π * P ) / 4$$

where F is force,
d is diameter of the cable, and
P is pressure applied.

During operation, the electrical motor 104 starts rotating at a predetermined speed calibrated depending on material composition, and diameter of the cable. The predetermined speed of the electrical motor 104 provides effective and controlled stripping without compromising integrity of internal conductors of the cable. The electrical motor system 102 may automatically adjust rotational parameters based on the use and type of cables. The cable material may be a soft copper conductor or a steel reinforced cable with multiple layers.

In an embodiment, the grinder stone 106 is configured to strip insulation from the cable and sharpen the end into a pointed configuration. The grinder stone 106 sharpens the blunt end into the precisely stripped cables through controlled abrasive actions that removes material at the predetermined rates and angles.

The electrical motor 104 generates and transfers rotational torque to the grinder stone 106 through a spindle or rotary coupling. The grinder stone 106 converts the rotational torque generated by the electrical motor 104 into controlled abrasive actions. The controlled abrasive actions remove cable materials and form a precisely pointed cable end.

In an embodiment, the spindle may be configured to rotate the grinder stone 106 with precision and streamlined operations. The direct spindle mounting provides a rigid mechanical connection to eliminate potential vibrations. The direct spindle mounting provides uniform removal of the material, and prepares precisely pointed cable.

In an embodiment, the grinder stone 106 is connected to an output shaft of the electrical motor 104 via a coupling mechanism (not illustrated). The coupling is designed to protect both the electrical motor 104 and the grinder stone 106 from shock loads that may occur during operation.

In an embodiment, the cable pointing tool 100 may include a plurality of precision blades configured to sharpen the end of the cable into a sharpened pointed shape through controlled cutting action. The plurality of precision blades may be arranged in circular pattern and circumferentially positioned around the output shaft of the electrical motor 104. Each of the precision blades may be precisely aligned at equal angular intervals around the circumference, maintaining uniform radial distance from a central axis.

In an embodiment, the protective shield 134 may provide passive protection and active debris management. The passive protection may be provided by use of a physical barrier. The physical barrier prevents accidental contact of the operator with the grinding stone 106 and minimizes the risk of injury from sparks. The shape of the protective shield 134 provides active protection function by collecting debris, dust, or small fragments generated during the stripping or shaping of the cable tip.

In an embodiment, the protective shield 134 may be manufactured using durable and lightweight materials. Materials such as plastic, rubber or silicone may be selected. In an example, a transparent plastic may be selected for transparency. The transparent plastic allows the operators to visually monitor the cable stripping process.

In an embodiment, the protective shield 134 may be attached around circumference of the grinder stone 106 using various fastening devices. The fastening devices such as a snap on clips, adjustable straps or adhesives may be used to secure the protective shield 134. The fastening devices are configured to provide a stable and vibration-resistant attachment during operation. The fastening devices further prevent accidental displacement or loosening of the protective shield 134.

The fastening devices may further include a quick-release mechanism. The quick-release mechanism may allow the operator to detach the protective shield 134 without the need for tools to replace or clean the protective shield 134. In one example, a spring-loaded latch or push-button may be used to disengage the fastening devices.

In an embodiment, the protective shield 134 may be integrated into a housing of the electrical motor 104 to form a single molded structure. The protective shield 134 may be integrated through injection molding or casting methods. The molded structure eliminates the need for separate fastening devices.

Referring to FIG. 3, illustrated is a perspective view of the grinder stone 106 of the electrical motor system 102, according to certain embodiments.

As described in FIG. 1A and FIG. 1B, the grinder stone 106 may be manufactured in various geometries to accommodate diverse cable processing requirements. The grinder stone 106 may be conical shaped, cylindrical or disc shaped. In the FIG. 3 example, the grinder stone 106 is conical shaped. The conical shape provides significant advantages through variable diameters. The conical shape provides efficient removal and precise shaping of the end of the cable during operation. In an embodiment, different conical taper angles or dimensional ratios may be used to accommodate variations in cable size, material composition, or desired sharpening characteristics.

The grinder stone 106 has a base surface 301 defined by an inner diameter 304 and an outer diameter 302. The outer diameter 302 represents a large base diameter and the inner diameter 304 represents a small base diameter. The larger base diameter of the grinding stone 106 is configured to provide aggressive initial material removal, while the smaller base diameter is configured to provide precise pointing of the cable ends.

In an embodiment, a ratio of the outer diameter 302 to the inner diameter 304 of the base surface 301 is around 1.4 to 1.6, for an optimal balance between grinding surface area and structural stability.

The grinder stone 106 may include multiple microscopic cutting edges distributed across the base surface 301. The multiple microscopic cutting edges engage with the cable surface and progressively remove materials through controlled friction and cutting. The grinder stone 106 may include abrasive particles, such as aluminum oxide, silicon carbide or ceramic selected for durability.

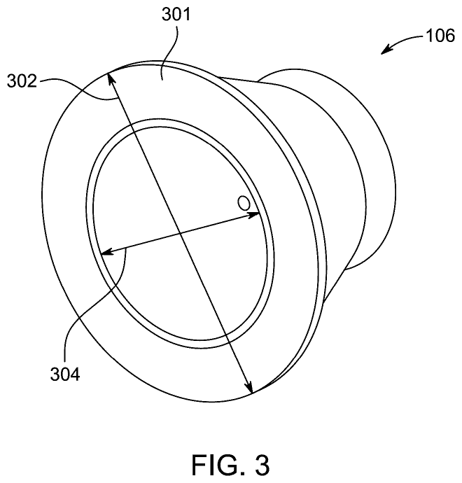

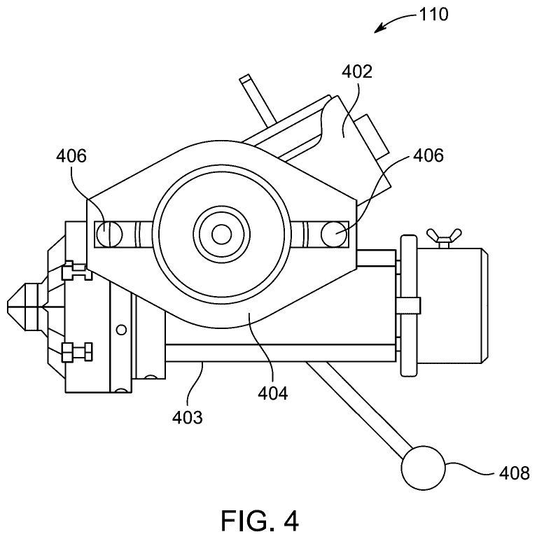

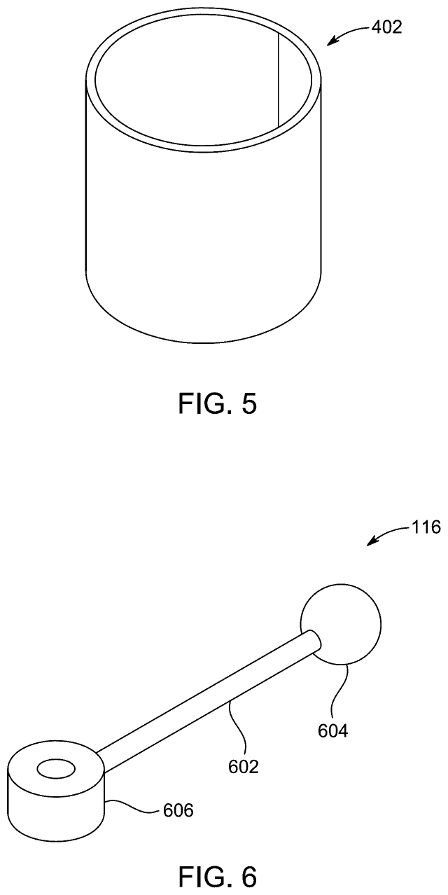

Referring to FIG. 4 and FIG. 5 in combination, illustrated are a bottom view of the cable holder 110 and a perspective view of a housing 402 of the cable holder 110, respectively, according to the embodiments of the present disclosure. The cable holder 110 includes the housing 402 configured to couple a main body 403 of the cable holder 110 with a circular disc shaped bottom base 404 using a support column 405 (shown in FIG. 1B). The circular disc shaped bottom base 404 includes a plurality of mounting holes 406 to mount the cable holder 110 on the track 114. The track 114 allows controlled movement of the cable holder 110 along the moving axis ‘X’.

The housing 402 serves as the structural enclosure for the cable guidance. According to the present disclosure, the housing 402 is cylindrical shaped and configured to support the cable holder 110.

The housing 402 may have an internal volume to accommodate a mounting structure of the cable holder 110 for precise cable positioning. The housing 402 is configured to be securely connected to the main body 403. The cable holder 110 further includes a handle 408 attached to the main body 403 for positional adjustments of the cable.

In an embodiment, the cable holder 110 may include multiple adjustable clamps configured to accommodate cables of varying diameters. The adjustable clamps may include a spring mechanism or jaw-type clamps that automatically adapt to cable diameter variations to secure retention without requiring manual adjustment of the cable holder 110.

Referring to FIG. 6, illustrated is a perspective view of the first handle 120 of the first handle module 116 of the cable pointing tool 100, according to certain embodiments. As described in FIG. 1A, the first handle 120 includes an elongated cylindrical rod 602 configured to provide a comfortable grip for the operator. The elongated cylindrical rod 602 is connected at one end to a bob 604 and another end to a connecting member 606. The elongated cylindrical rod 602 is mechanically coupled to the first axle 122 via the connecting member 606, allowing the first handle 120 to transmit precise rotational or linear movement. In certain embodiments, the bob 604 may be attached to the first handle 120 to improve balance and reduce the effort required for precise adjustments.

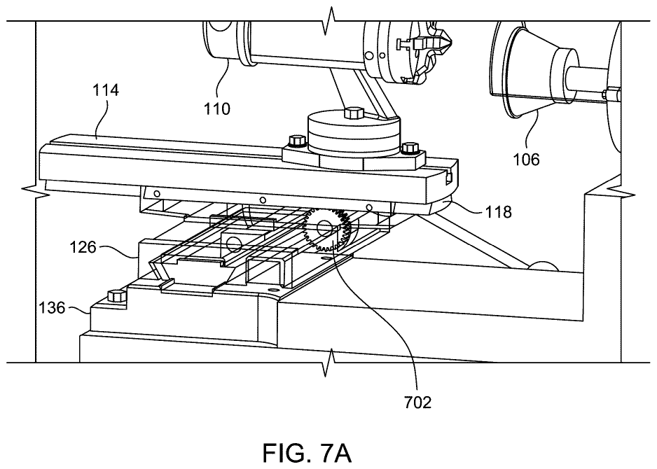

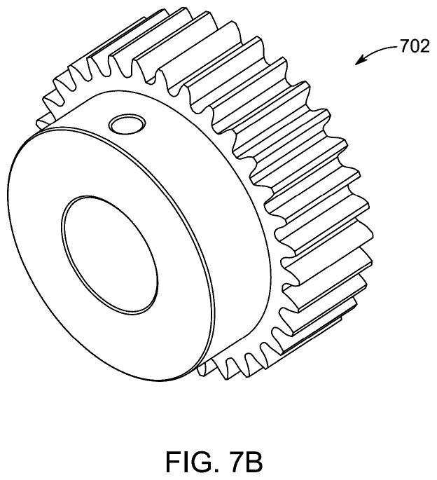

Referring to FIG. 7A and FIG. 7B in combination, illustrated are a schematic partial perspective view of the cable pointing tool 100 showing internal components including a gear 702 and a perspective view of the gear 702, respectively, according to certain embodiments. The second base 126 includes the gear 702 configured to transfer the rotational motion from the first handle 120 to the track 114. The gear 702 is rotatably attached to the second base 126. The gear 702 moves the cable holder 110 along the moving axis of the track 114.

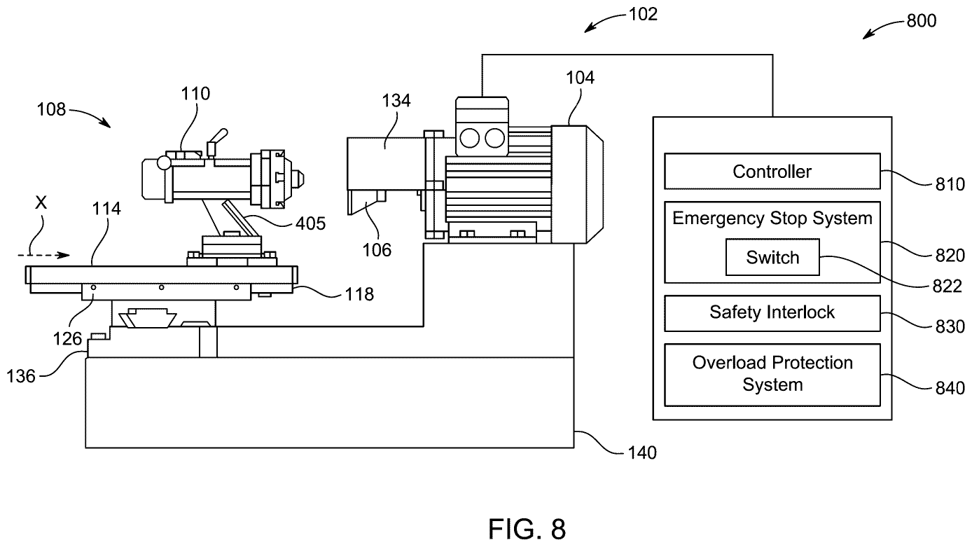

FIG. 8 is a schematic block diagram illustrating the cable pointing tool 100 with a control system 800 including an emergency stop system 820 and a safety interlock 830, according to certain embodiments. In an embodiment, the electrical motor system 102 further includes the control system 800 configured to control activation or deactivation of the grinder stone 106, and speed regulation of the electrical motor 104 during cable pointing operations. The control system 800 enables the required precision and consistency.

In an embodiment, the control system 800 may be mounted directly on the electrical motor 104 or in close proximity to the electrical motor system 102. The control system 800 may include a controller 810 and a sensor. The sensor may be configured to monitor the performance of the electrical motor 104 and provide real time data to the controller 810. The controller 810 may be configured to adjust the movement of the grinder stone 106. The controller 810 may be configured to start or stop the rotation of the grinder stone 106. The controller 810 may regulate the speed of the electrical motor 104 to accommodate variations in cable size, material composition, or desired sharpening characteristics.

In an embodiment, the control system 800 is implemented as either an electrical or a hydraulic system, depending on the operational requirements and environmental constraints of the application.

In an embodiment, an electrical control system may include a sensor, an actuator, a microcontroller, a relay, and a wiring. The sensor may be configured to detect correct positioning of the cable or the presence of the protective shield 134. The sensor sends signals to the microcontroller. The microcontroller may receive input from the sensor and evaluates whether predefined safety or operational criteria are met.

The microcontroller sends a control signal to the relay. The relay controls the power supply to the actuator to activate the grinder stone 106. The components are connected to each other by means of wiring.

In an embodiment, a hydraulic control system may utilize pressurized fluid to transmit power and control movement. The hydraulic control system may include various pumps, valves, cylinders, and fluid reservoirs.

In an embodiment, the cable pointing tool 100 includes the emergency stop system 820 configured to halt the electrical motor 104 in case of an emergency. The emergency stop system 820 improves the safety and reliability of the cable pointing tool 100, during operations. The emergency stop system 820 includes an easily accessible switch 822. The easily accessible switch 822 is electrically coupled to the control system 800, allowing the operator to override normal operational commands when activated. The easily accessible switch 822 is configured to immediately interrupt the power supply to the electrical motor 104 to stop rotation of the electrical motor 104 in case of the emergency. Upon pressing the easily accessible switch 822, the electrical motor 104 ceases operation instantaneously.

During operation, if an emergency arises such as unexpected movement, or a safety hazard, the operator presses the easily accessible switch 822 to immediate cessation of the rotation of the electrical motor 104, allowing the situation to be assessed and resolved safely.

In an embodiment, the cable pointing tool 100 further includes a safety interlock 830 configured to ensure that the grinder stone 106 operates only when the cable is correctly positioned and the protective shield 134 is in place. The safety interlock 830 is configured to increase operational safety and prevent unintended activation of the grinder stone 106. The safety interlock 830 ensures that the grinder stone 106 operates only when two critical conditions are met: the cable is correctly positioned within the cable holder 110; and the protective shield 134 is securely in place.

The safety interlock 830 may include sensors interconnected with the safety interlock 830. The safety interlock 830 permits activation of the electrical motor 104 only when both safety criteria are satisfied. If either the cable is misaligned or the protective shield 134 is not properly installed, the safety interlock 830 prevents the grinder stone 106 from rotating.

During operation, the safety interlock 830 acts as a safeguard against accidental contact with the grinder stone 106. For example, if the operator attempts to start the cable pointing tool 100 without securing the protective shield 134, the safety interlock 830 will block the activation of the electrical motor 104 until the protective shield 134 is correctly positioned.

In an embodiment, the safety interlock 830 may include a mechanical switch to safely operate the grinder stone 106. The mechanical switch may be positioned to engage only when the cable is correctly placed in the cable holder 110 and the protective shield 134 is securely installed. If either the cable is misaligned or the protective shield 134 is missing, the mechanical switch remains in the “off” position, preventing the grinder stone 106 from rotating.

In an embodiment, the cable pointing tool 100 further includes an overload protection system 840, configured to prevent the electrical motor 104 from operating under excessive load. The overload protection system 840 may protect the electrical motor 104 from damage due to excessive current drawn. When the electrical motor 104 draws more current than the rated capacity, the excessive current may overheat and damage the internal components. The overload protection system 840 is configured to detect the excessive current drawn condition of the electrical motor 104 and interrupt the power supply.

In an embodiment, the overload protection system 840 may be a thermal overload protection system or an electronic overload protection system. The overload protection system 840 may measure the current drawn by the electrical motor 104. If the current drawn exceeds a predefined limit, the overload protection system 840 may be configured to send a signal to the controller 810. The controller 810 of the control system 800 may receive the signal and be configured to interrupt the power supply to the electrical motor 104.

During operation, the operator powers on the cable pointing tool 100. The electrical motor 104 starts rotating at a predefined speed and generates rotational torque, which is transferred to the grinder stone 106 through the spindle. The electrical motor 104 generates a precision force. The grinder stone 106 converts the rotational torque into controlled abrasive actions that remove cable materials and form precisely pointed cable ends. The protective shield 134 is positioned over the grinder stone 106 to prevent direct operator contact with the rotating grinder stone 106 and containing debris generated during the cable pointing operation. The pointing system 108 provides accurate cable positioning relative to the grinding stone 106. The cable holder 110 is mounted onto the track 114 in a configuration that allows precise movement along the moving axis ‘X’. The track 114 is mounted on the first base 118 to provide structural stability and positioning accuracy. The operator controls cable positioning using the mechanical dual-handle system 112. The first handle module 116 allows movement of the cable holder 110 along the moving axis ‘X’ of the track 114 and the second handle module 124 provides lateral movement in the axis ‘Y’ perpendicular to the moving axis ‘X’. The control system 800 controls activation or deactivation of the grinder stone 106 and regulates the speed of the electrical motor 104 during cable pointing operations.

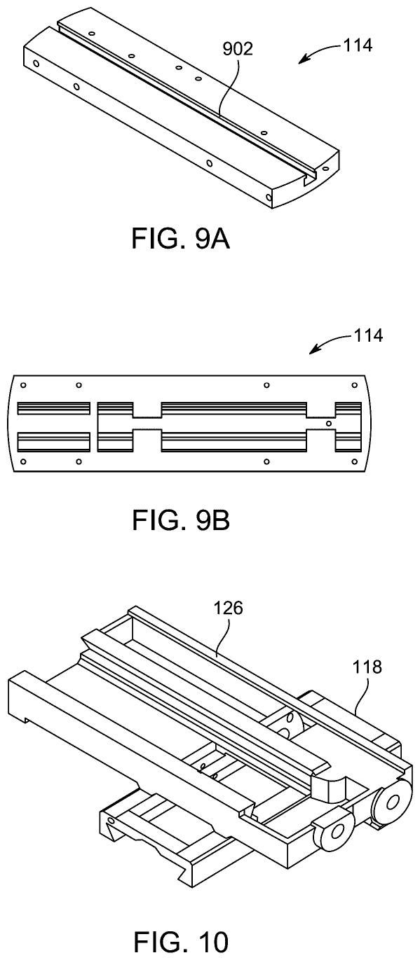

Referring to FIGS. 9A and 9B, in combination, illustrated are a perspective view and a bottom view, respectively, of the track 114 of the cable pointing tool 100, according to certain embodiments. The track 114 serves as a structural interface for the cable holder 110 to movably engage with the first base 118. The track 114 is movably engaged with the first base 118. The track 114 is rectangular shaped with a guiding rail 902 for smooth and controlled motion. The track 114 is configured to mount and secure attachment of the cable holder 110 for the movement along the moving axis ‘X’. The track 114 further provides mechanical integrity of the cable pointing system 108.

Referring to FIG. 10, illustrated is a bottom perspective view of the second base 126 and the first base 118 of the cable pointing tool 100, according to certain embodiments. The second base 126 has mounting holes for the secure attachment of the first handle 120 and the second handle 128. The first base 118 and the second base 126 may be formed as an integral component manufactured using a molding process. The first base 118 is configured to movably engage with the track 114 to allow movement of the cable holder 110 in the moving axis ‘X’ whereas the second base 126 allows movement of the cable holder 110 in the axis ‘Y’ perpendicular to the moving axis ‘X’. The second base 126 is configured to accommodate the gear 702 along with the first handle module 116 to facilitate movement of the cable holder 110 in the moving axis ‘X’. The second base 126 may be further movably attached to the third base 136 via a linear actuating mechanism to facilitate movement of the cable holder 110 in the axis ‘Y’ perpendicular to the moving axis ‘X’.

Referring to FIG. 11, a perspective view of the third base 136 is illustrated, according to certain embodiments. The third base 136 is configured to movably support the second base 126 and detachably couple with the main base 140 using the fastening members. The third base 136 includes a platform configured to support a guide mechanism 1102. The guide mechanism 1102 is configured to slidably engage with the second base 126 such that the cable holder 110 may be moved along the axis ‘Y’ perpendicular to the moving axis ‘X’. In an embodiment, an extended portion 1104 may be removed from the platform of the third base 136.

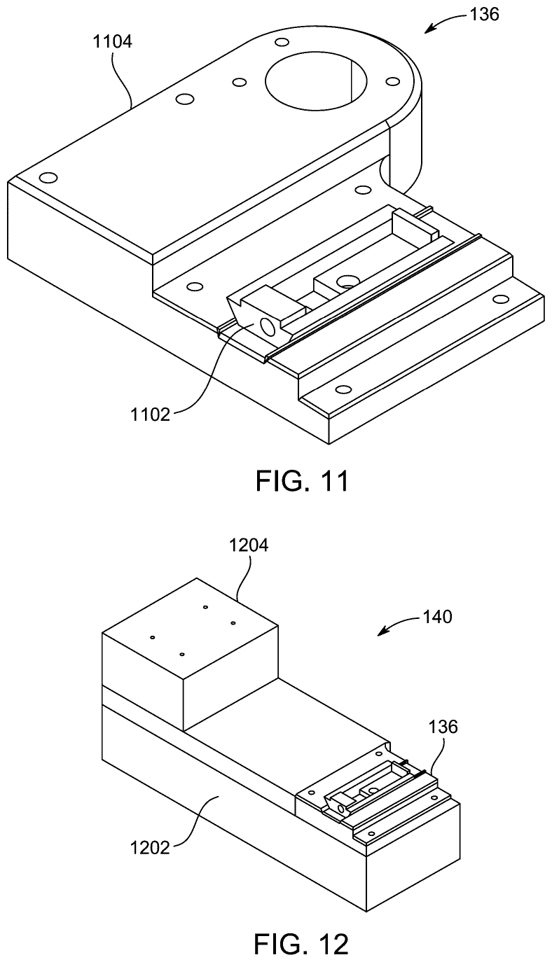

Referring to FIG. 12, illustrated is a perspective view of the main base 140 of the cable pointing tool 100, according to certain embodiments. The main base 140 functions as the primary structural foundation of the cable pointing tool 100 supporting and integrating all components. The main base 140 is configured to support the third base 136, which is configured to support the second base 126 and the first base 118. The main base 140 is configured to securely hold the electrical motor system 102 and the pointing system 108. In particular, the main base 140 includes a horizontal platform 1202 having one end configured to detachably couple the third base 136 to support the pointing system 108 and another end includes a raised platform 1204 configured to support the electrical motor system 102. The main base 140 may be firmly positioned on a ground surface. In an embodiment, the main base 140 may be designed to accommodate the control system 800 of the cable pointing tool 100.

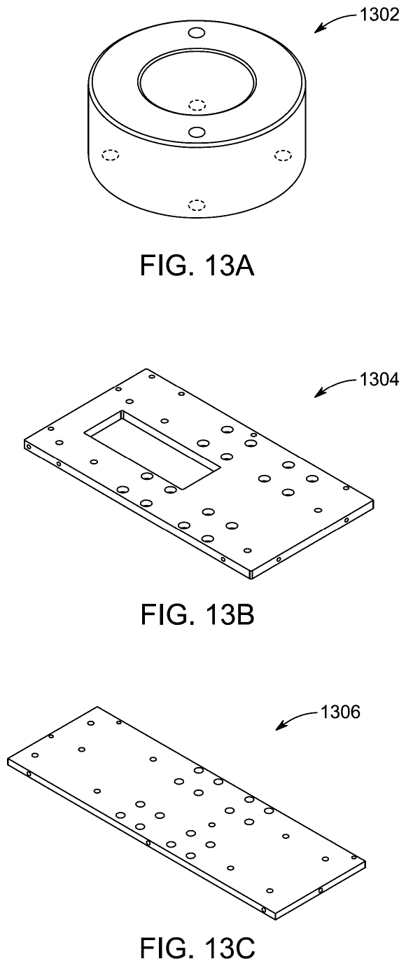

Referring to FIG. 13A, FIG. 13B, and FIG. 13C, illustrated are perspective views of a base column 1302, a fourth base 1304, and a fifth base 1306, respectively, of the cable pointing tool 100, according to certain embodiments. The base column 1302 is cylindrical shaped with an inner diameter and an outer diameter. The fourth and fifth bases 1304, 1306 function as intermediate structural components. Each of the fourth and fifth bases 1304, 1306 is rectangular shaped and has multiple cavities, and is configured to provide proper fixation to the main base 140 and the first, second, and third bases 118, 126, 136.

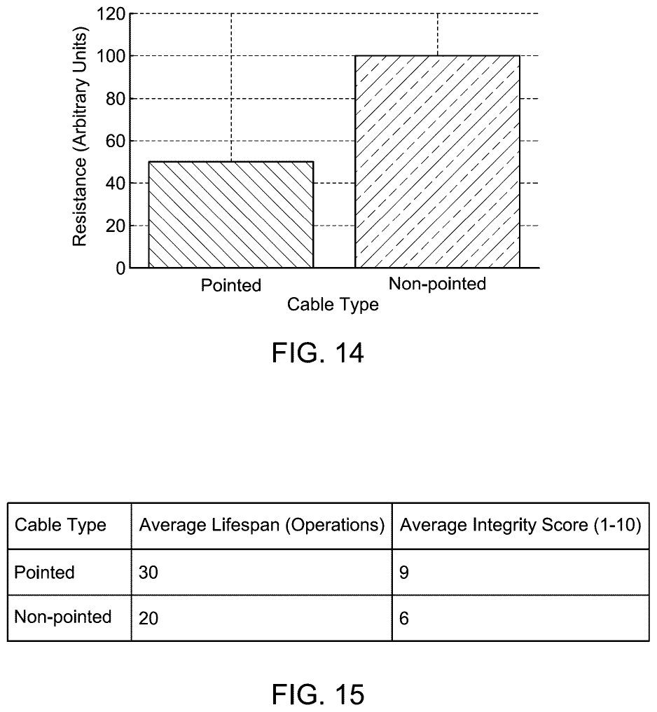

Referring to FIG. 14, illustrated is a graphical representation measuring resistance for pointed cable vs non-pointed cable, according to certain embodiments. As illustrated in graph, the resistance measurements for pointed cable and non-pointed cable have been compared under identical test conditions. The pointed cable achieves a reduction in electrical resistance of approximately 50% relative to the non-pointed cable. In contrast, the non-pointed cable exhibits higher resistance values, which may lead to increased energy losses, greater heat buildup, and potentially accelerated material degradation over time.

Referring to FIG. 15, illustrated is a tabular representation showing cable integrity and longevity data post operation for the pointed cable vs non-pointed cables, according to certain embodiments. This is observed from findings that the pointed cable demonstrates better performance as compared to the non-pointed cable. The pointed cable exhibits an average integrity score of 9 points, providing structural integrity with minimal degradation over time and an average service life of approximately 30 years. In contrast, the non-pointed cable shows a lower average integrity score of 6 points and an average service life of approximately 20 years. The pointed cables feature improved mechanical stability, better load distribution, and potentially superior resistance to mechanical stress and corrosion. The significant difference in both integrity score and service life highlights the advantages of adopting the pointed cable design in applications where long-term reliability and performance are critical.

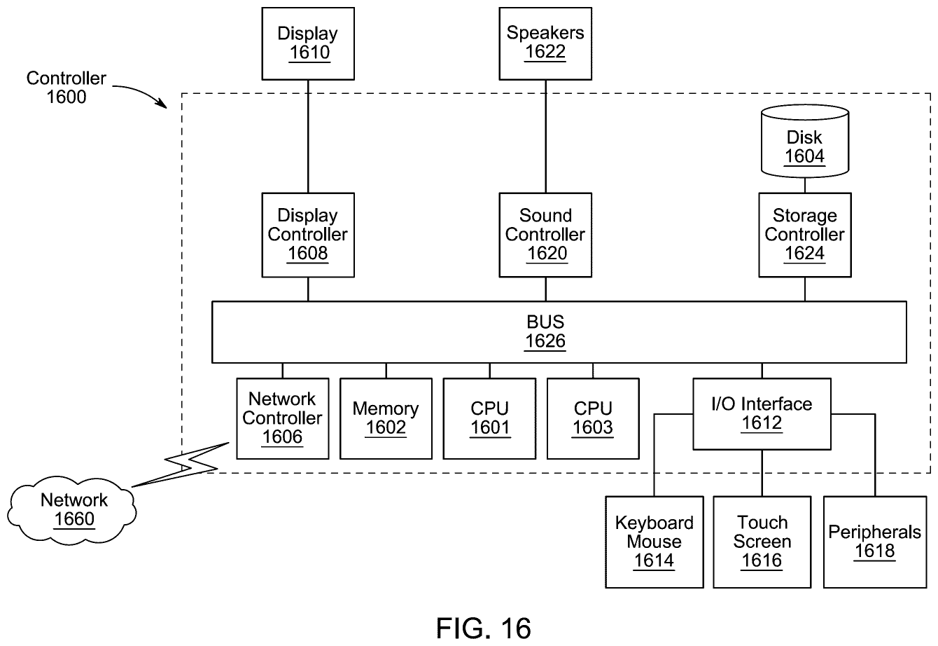

Next, further details of the hardware description of the computing environment according to exemplary embodiments are described with reference to FIG. 16. In FIG. 16, a controller 1600 is described embodying the controller 810 of the cable pointing tool 100 of the present disclosure, in which the controller is a computing device which includes a CPU 1601 which performs the processes described above/below. The process data and instructions may be stored in memory 1602. These processes and instructions may also be stored on a storage medium disk 1604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1601, 1603 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1601 or CPU 1603 may be a Xenon or Core processor from Intel of America or an Opteron processor from AMD of America, or may be other processor types that would be recognized by one of ordinary skill in the art. Alternatively, the CPU 1601, 1603 may be implemented on an FPGA, ASIC, PLD or using discrete logic circuits, as one of ordinary skill in the art would recognize. Further, CPU 1601 and 1603 may be implemented as multiple processors cooperatively working in parallel to perform the instructions of the inventive processes described above.

The computing device in FIG. 16 also includes a network controller 1606, such as an Intel Ethernet PRO network interface card from Intel Corporation of America, for interfacing with network 1660. As can be appreciated, the network 1660 can be a public network, such as the Internet, or a private network such as an LAN or WAN network, or any combination thereof and can also include PSTN or ISDN sub-networks. The network 1660 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

The computing device further includes a display controller 1608, such as a NVIDIA GeForce GTX or Quadro graphics adaptor from NVIDIA Corporation of America for interfacing with display 1610, such as a Hewlett Packard HPL2445w LCD monitor. A general purpose I/O interface 1612 interfaces with a keyboard and/or mouse 1614 as well as a touch screen panel 1616 on or separate from display 1610. General purpose I/O interface also connects to a variety of peripherals 816 including printers and scanners, such as an OfficeJet or DeskJet from Hewlett Packard.

A sound controller 1620 is also provided in the computing device such as Sound Blaster X-Fi Titanium from Creative, to interface with speakers/microphone 1622 thereby providing sounds and/or music.

The general purpose storage controller 1624 connects the storage medium disk 1604 with communication bus 1626, which may be an ISA, EISA, VESA, PCI, or similar, for interconnecting all of the components of the computing device. A description of the general features and functionality of the display 1610, keyboard and/or mouse 1614, as well as the display controller 1608, storage controller 1624, network controller 1606, sound controller 1620, and general purpose I/O interface 1612 is omitted herein for brevity as these features are known.

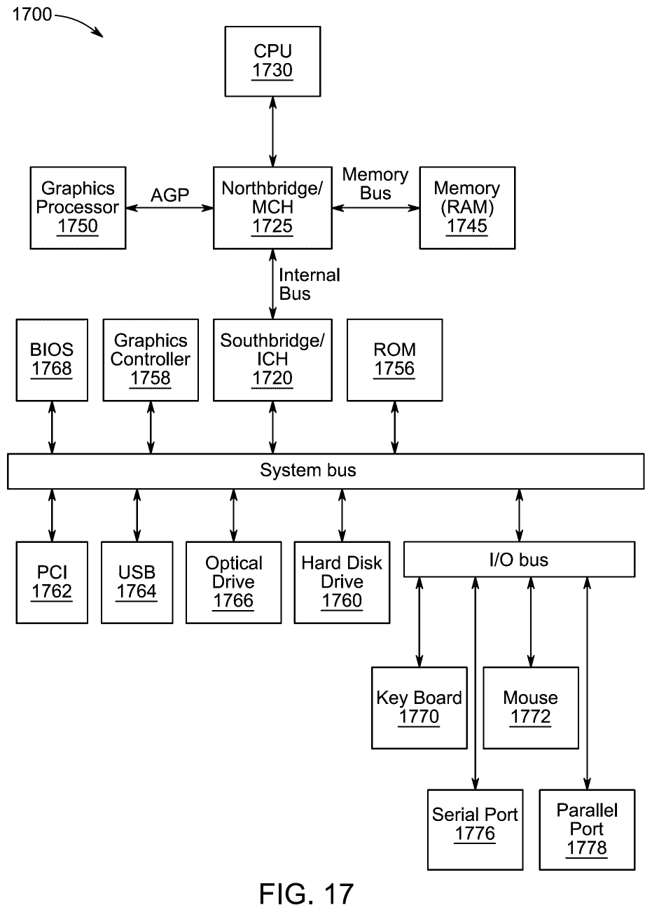

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 17.

FIG. 17 shows an exemplary schematic diagram of a data processing system, according to certain embodiments, for performing the functions of the exemplary embodiments. The data processing system is an example of a computer in which code or instructions implementing the processes of the illustrative embodiments may be located.

In FIG. 17, data processing system 1700 employs a hub architecture including a north bridge and memory controller hub (NB/MCH) 1725 and a south bridge and input/output (I/O) controller hub (SB/ICH) 1720. The central processing unit (CPU) 1730 is connected to NB/MCH 1725. The NB/MCH 1725 also connects to the memory 1745 via a memory bus, and connects to the graphics processor 1750 via an accelerated graphics port (AGP). The NB/MCH 1725 also connects to the SB/ICH 1720 via an internal bus (e.g., a unified media interface or a direct media interface). The CPU Processing unit 1730 may contain one or more processors and even may be implemented using one or more heterogeneous processor systems.

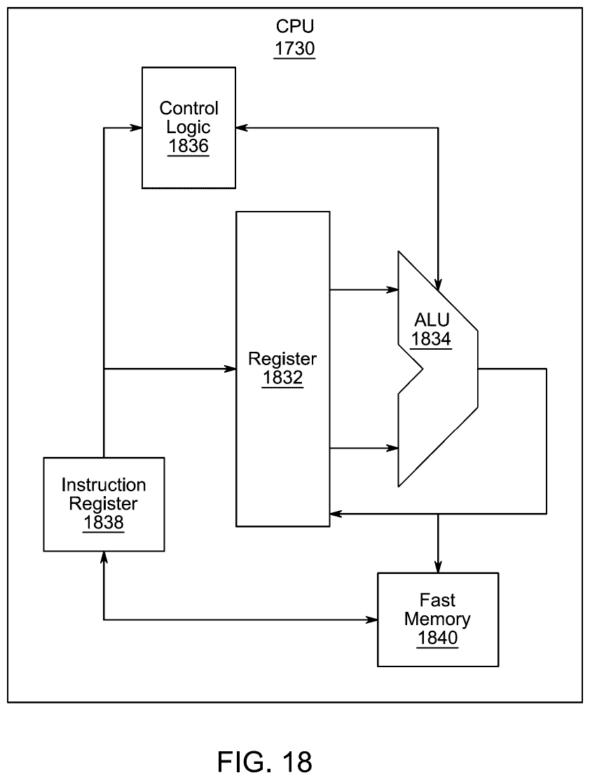

For example, FIG. 18 shows one implementation of CPU 1730. In one implementation, the instruction register 1838 retrieves instructions from the fast memory 1840. At least a part of these instructions is fetched from the instruction register 1838 by the control logic 1836 and interpreted according to the instruction set architecture of the CPU 1730. Part of the instructions can also be directed to the register 1832. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1834 that loads values from the register 1832 and performs logical and mathematical operations on the loaded values according to the instructions. The results from these operations can be feedback into the register and/or stored in the fast memory 1840. According to certain implementations, the instruction set architecture of the CPU 1730 can use a reduced instruction set architecture, a complex instruction set architecture, a vector processor architecture, and a very large instruction word architecture. Furthermore, the CPU 1730 can be based on the Von Neuman model or the Harvard model. The CPU 1730 can be a digital signal processor, an FPGA, an ASIC, a PLA, a PLD, or a CPLD. Further, the CPU 1730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 17, the data processing system 1700 can include that the SB/ICH 1720 is coupled through a system bus to an I/O Bus, a read only memory (ROM) 1756, universal serial bus (USB) port 1764, a flash binary input/output system (BIOS) 1768, and a graphics controller 1758. PCI/PCIe devices can also be coupled to SB/ICH 1788 through a PCI bus 1762.

The PCI devices may include, for example, Ethernet adapters, add-in cards, and PC cards for notebook computers. The Hard disk drive 1760 and CD-ROM 1766 can use, for example, an integrated drive electronics (IDE) or serial advanced technology attachment (SATA) interface. In one implementation the I/O bus can include a super I/O (SIO) device.

Further, the hard disk drive (HDD) 1760 and optical drive 1766 can also be coupled to the SB/ICH 1720 through a system bus. In one implementation, a keyboard 1770, a mouse 1772, a parallel port 1778, and a serial port 1776 can be connected to the system bus through the I/O bus. Other peripherals and devices that can be connected to the SB/ICH 1720 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

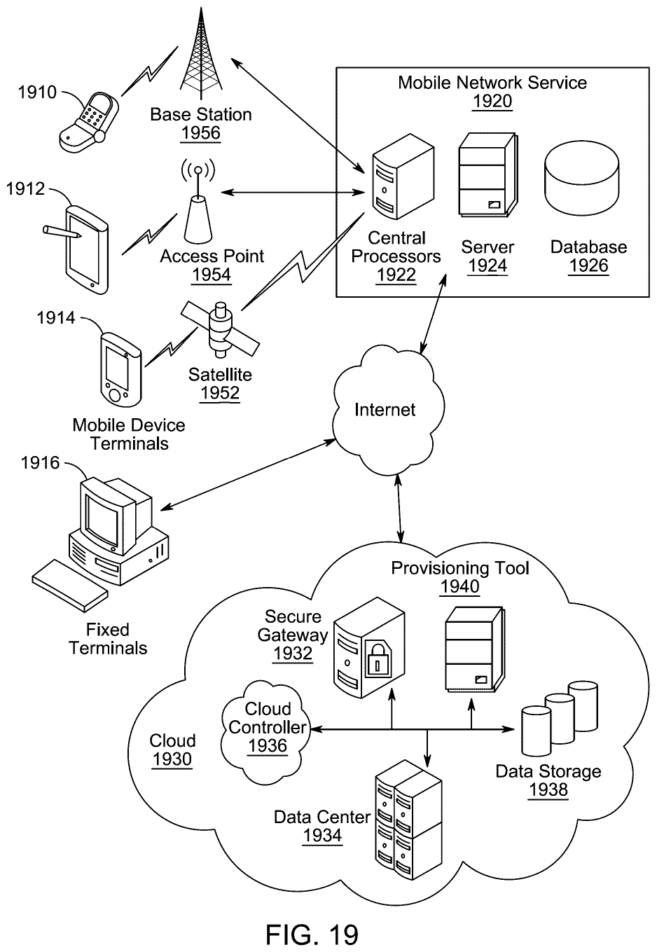

The functions and features described herein may also be executed by various distributed components of a system. For example, one or more processors may execute these system functions, wherein the processors are distributed across multiple components communicating in a network. The distributed components may include one or more client and server machines, such as cloud 1930 including a cloud controller 1936, a secure gateway 1932, a data center 1934, data storage 1938 and a provisioning tool 1940, and mobile network services 1920 including central processors 1922, a server 1924 and a database 1926, which may share processing, as shown by FIG. 19, in addition to various human interface and communication devices (e.g., display monitors 1916, smart phones 1910, tablets 1912, personal digital assistants (PDAs) 1914). The network may be a private network, such as a LAN, satellite 1952 or WAN 1954, or be a public network, may such as the Internet. Input to the system may be received via direct user input and received remotely in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A cable pointing tool, comprising:
an electrical motor system comprising an electrical motor and a grinder stone powered by the electrical motor to sharpen an end of a cable;
a pointing system comprising a cable holder and a mechanical dual-handle system, the cable holder configured to hold the cable, and the mechanical dual-handle system configured to guide the cable towards the grinder stone; and
a main base on which the electrical motor system and the pointing system are mounted.

2. The cable pointing tool of claim 1, wherein the electrical motor system further comprises a protective shield covering the grinder stone.

3. The cable pointing tool of claim 1, wherein the pointing system further comprises a track on which the cable holder is mounted such that the cable holder is movable along a moving axis of the track, and
a second holder mounted behind the cable holder and fixed in a non-movable position on the track, wherein the second holder contacts the cable with an interior surface of a polyurethane foam cylinder.

4. The cable pointing tool of claim 3, wherein the mechanical dual-handle system includes a first handle module configured to move the cable holder along the moving axis of the track.

5. The cable pointing tool of claim 4, wherein the first handle module includes a first base and a first handle connected to the first base through a first axle.

6. The cable pointing tool of claim 5, wherein the track is mounted onto the first base.

7. The cable pointing tool of claim 5, wherein the cable holder is moved along the moving axis of the track through rotation of the first handle.

8. The cable pointing tool of claim 4, wherein the mechanical dual-handle system further includes a second handle module configured to move the cable holder along an axis perpendicular to the moving axis of the track.

9. The cable pointing tool of claim 8, wherein the second handle module includes a second base and a second handle connected to the second base through a wheel and a second axle.

10. The cable pointing tool of claim 9, wherein the first handle module is mounted onto the second base.

11. The cable pointing tool of claim 9, wherein the cable holder is moved along the axis perpendicular to the moving axis of the track through rotation of the second handle.

12. The cable pointing tool of claim 9, wherein the second base comprises a gear configured to move the cable holder along the moving axis of the track.

13. The cable pointing tool of claim 1, wherein the grinder stone is conical-shaped.

14. The cable pointing tool of claim 13, wherein the conical-shaped grinder stone has a base surface of which a ratio between an outer diameter and an inner diameter is around 1.4 to 1.6.

15. The cable pointing tool of claim 1, wherein the electrical motor system further comprises a control system configured to control motor activation, motor deactivation, and speed regulation of the electrical motor.

16. The cable pointing tool of claim 15, wherein the control system is an electrical or hydraulic system.

17. The cable pointing tool of claim 1, further comprising an emergency stop system configured to halt the electrical motor in case of an emergency.

18. The cable pointing tool of claim 17, wherein the emergency stop system comprising an easily accessible switch that immediately halts the electrical motor in case of the emergency.

19. The cable pointing tool of claim 1, further comprising a safety interlock configured to ensure the grinder stone operates only when the cable is correctly positioned and a protective shield is in place.

20. The cable pointing tool of claim 1, further comprising an overload protection configured to prevent the electrical motor from operating under excessive load.
